(19) United States
(12) Patent Application Publication
(10) Pub. No.: US 2004/0207167 A1
(43) Pub. Date: Oct. 21, 2004

(54) Folding tote with bag

(76) Inventor: Darren J. Kady, Glen Allen, VA (US)

Correspondence Address: Parker & DeStefano, Suite 300, 300 Preston Avenue, Charlottesville, VA, 22902, US

(21) Appl. No.: 10/841,864

(22) Filed: May 7, 2004

Related U.S. Application Data
(63) Continuation of application No. 10/315,577, filed on Dec. 10, 2002.
(60) Provisional application No. 60/339,009, filed on Dec. 10, 2001.

(51) Int. Cl. B62B 1/10

(52) U.S. Cl. 280/40; 280/652

(57) ABSTRACT

The disclosed redesigned folding tote includes a release mechanism located on one of the handles to release one or more locking mechanisms located on the platform. One of the locking mechanisms maintains the platform in an open position while another locks the platform into the folded, closed position. When released from the closed position, a spring on the underside of the platform facilitates the opening of the wheel support frame. Slides lock the handles in the desired position relative to one another and are slide along the handles evenly through use of stop members. Rotating spacers protect the tote as it is brought up stairs or curbs.

### CROSS REFERENCE TO RELATED APPLICATION

This application is a continuation in part of U.S. Ser. No. 10/315,577 filed Dec. 10, 2002, which is a continuation in part of provisional 60/339,009 filed on Dec. 10, 2001, which are incorporated herein as through recited in full.

### BACKGROUND OF THE INVENTION

1. Field of the Invention

This invention relates to a folding tote with increased stability and a release handle that enables single-handed opening.

2. Brief Description of the Prior Art

The present invention relates to an improvement to prior art foldable totes for shopping, of the type having a wheeled framework to which the bottom of the bag is attached. In the prior art, the wheels of the tote are welded to corresponding frameworks, articulated to a resistant base situated beneath the bottom of the bag, the frameworks being folded. In some cases, the bag handle is a double handle, formed by two “U”-tubes being parallelly displaced, which are extended only when the bag is pulled on its fixed wheels and are withdrawn in order to carry the bag hanging on the hand or on the arm of the user. Different types of frameworks allow folding, together with the bag and the wheels, in order to convert the assembly into a bag of reduced size to be carried hanging on the user's arm until the moment when shopping is done, at which time the wheels are extended and unfolded so that the loaded bag leans on the wheels to make transport easier.

In U.S. Pat. No. 4,989,889, the prior art discloses a foldable tote for shopping having a wheeled framework to which the bottom of the bag is attached. The framework allows the wheels to be folded under the base, and the bag-framework assembly to be folded on the opposing side of the base. The object of the '889 patent was to provide a foldable shopping tote of the type which can be converted into a bag of reduced size that automatically unfolds the bag and wheels when the frameworks of the tote are extended. To accomplish this, one of the frameworks has been provided with points of junction over the top portion of the bag and the other framework is attached to the resistant plate that supports the bottom of the bag. They are retained in the extended, or unfolded, position until the user “closes” the device.

### BRIEF DESCRIPTION OF THE DRAWINGS

The advantages of the instant disclosure will become more apparent when read with the specification and the drawings, wherein:

FIG. 1 is a side view of one embodiment of the tote in the open position,

FIG. 2 is a side view of the tote of FIG. 1 in the closed position,

FIG. 3 is a back view of the closed tote of FIG. 1;

FIG. 4 is a perspective view of the support frame for the tote of FIG. 1 in the closed position;

FIG. 5 is a perspective view of the support frame of FIG. 4 in the open position;

FIG. 6 is a cutaway side view of the handle locking system of the preferred embodiment;

FIG. 7 is a cutaway front view of the handle release system of the handle of FIG. 6;

FIG. 8 is a side view of another embodiment of the disclosed tote with the cover partially open;

FIG. 9 is a front view of the cover of the tote;

FIG. 10 is a side view of the back wheels of the system;

FIG. 11 is a bottom view of the platform in the open position;

FIG. 12 is a bottom view of the platform in the first stage of closing with the platform and handle brace on the same plane;

FIG. 13 is a bottom view of the platform of FIG. 12 with the support frame in the closed position;

FIG. 14 is a bottom view of the platform in the closed position;

FIG. 15 is a perspective view of the beveled handle lock;

FIG. 16 is a side view of the upper handle and the lower handle in the extended position;

FIG. 17 is a side view of the upper handle positioned to engage the stop member with the locking slide;

FIG. 18 is a side view of the upper handle and engaged locking slide descending;

FIG. 19 is a side view of the upper handle and lower handle in the closed position.

FIG. 20 is a partial side view of the open tote;

FIG. 21 is a side view of the folded tote; and

FIG. 22 is a side view of the locking mechanism for maintaining the tote in an open position.

### DETAILED DESCRIPTION OF THE INVENTION

The disclosed folding tote improves over the prior art designs by enabling single handed opening locking in both the open and closed positions, a single lock release, as well as a larger design and easier loading. Due to these changes, the design and proportioning of the bag, platform and release mechanisms become more exacting.

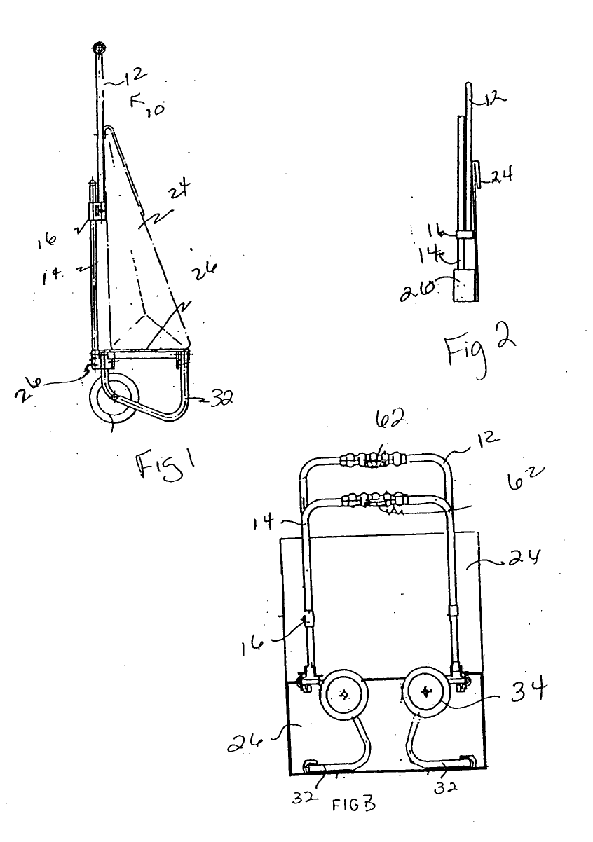

In FIG. 1, the tote 10 is illustrated in the upright position with the upper handle 12 being held in the raised position above the lower handle 14 through the use of locking slides 16. The locking slides 16, which slide freely along the upper handle 12 and the lower handle 14, can lock the upper handle 12 in any position convenient to the user, relative to the lower handle 14, through use of any number of locking mechanisms known in the art. The support frame 32, works in conjunction with the wheels 34 to maintain the tote 10 in the upright position and prevent tipping. The bag 24 is secured to the upper handle 12 as well as to the base 26 to facilitate opening of the bag 24 simultaneously with the opening of the tote 10. Preferably the bag 24 is secured in a removable manner to enable the bags 24 to be changed. The bags can be secured to the base 26 through use of hook and loop material, snaps, slides or any equivalent method that enables the bag to be easily removed and reattached. The ability to remove the bag enables the user to replace a bag used for laundry with an insulated bag for shopping. The ability to substitute bags also reduces the cost as the user does not need a frame for each use.

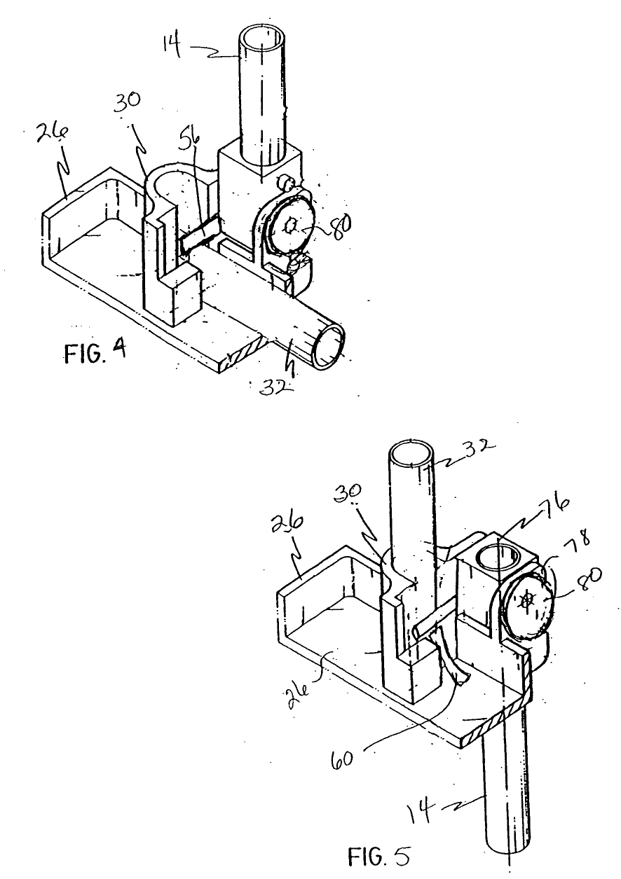

As seen in FIGS. 2 and 3, when the base 26 is placed in the folded position, the base 26 is placed directly below and on the same plane as the handles 12 and 14. The front of the bag 24 is thus pulled downward, forcing the bag 24 to lie flat against the handles 12 and 14.

The improvements over the prior art on the disclosed device provide an increased ease of operation and usability. The structural changes disclosed herein enable the folding tote to be larger than prior art bags while providing increased functionality. In the prior art device, all opening and closing was done manually. For people with any debilitating medical problem, such arthritis or back injury, or the elderly, the lifting of the tote can present a problem.

One of the ways the disclosed tote has been made easier to use is by enabling the support frame 32 and wheels 34 to open automatically when the base 26 is unfolded to its usable position of 90 degrees from the handles 12 and 14. To release the support frame 32 and wheels 34 from their folded position, the lower release button 62 is activated, thereby prompting the support frame 32 into the open position.

One method of accomplishing this is providing a spring mechanism positioned to interact with the support frames 32, pushing them into an open position once the restraint is removed. An example of this is shown in the embodiment illustrated in FIGS. 4 and 5, wherein the support frames 32 are maintained in the close position through the use of a locking bar 56. The locking bar 56 is connected to the lower release button 50 through wires within the handle 14. Recessing the lower handle release 62 pulls the locking bar 56 into a position parallel with the handle 14 while releasing the lower release button 50 permits the locking bar 56 to return to its position at right angles to the handle 14. To force the support frame 32 into the open position, a spring 57 is placed between the support frames 32 and the base 26. Once the locking bar 56 is released, the pressure applied by the spring 57 returning to its uncompressed state forces the support frame 32 into the open position. The lower handle release 62 is then released, enabling the locking bar 56 to fall back into its position parallel with the base 26, as illustrated in FIG. 5. Alternatively, the design can be such that the locking bar remains at a 90 degree angle to the based until the support frame 32 are closed. It should be noted that the spring can be any type applicable, as known in the art, and can be placed on either the front (as illustrated), base or the back of the base 26, dependent upon manufacturer's design.

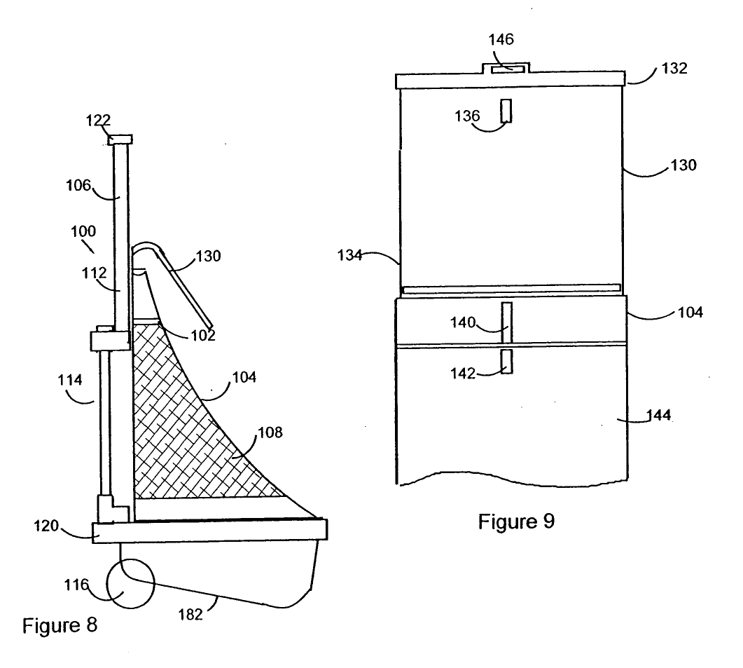

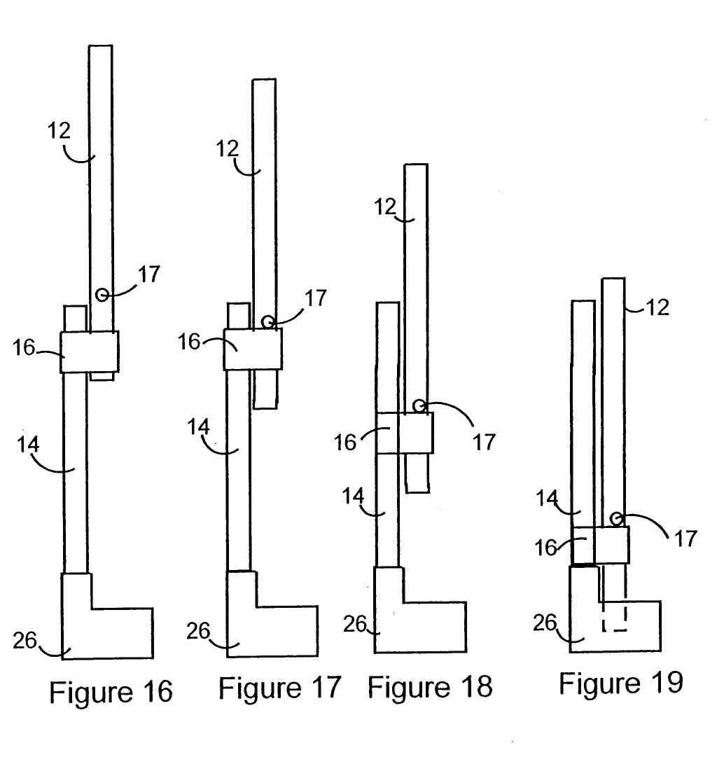

Although the slide releases can be immovably affixed to the ends of the upper handle and slide only along the lower handle, it is preferable, especially with the larger design of the preferred embodiment illustrated hereinafter, that the slide releases 116, as seen in FIG. 8, slide along both the upper handle 112 and the lower handle 114. In order to keep the slide releases 116 moving along the lower handle 114 evenly, the upper handle 112 has a stop member 117, on the outer side of each of the upper handles 112. When the upper handle 112 is extended fully, as seen in FIG. 16, the stop member 117 is spaced above the slide release 116. As the upper handle 112 is pressed downward, the stop member 117 engages the slide release 116 thereby moving the pair of slide releases 116 downward simultaneously at an horizontal, or close to horizontal, level as seen in FIG. 18. The stop member 117 is spaced above the lower end of the upper handle 112 a sufficient distance to enable the upper handle 112 to fully recess into the base or platform 120 prior to the slide release 116 contacting the platform 120 as seen in FIG. 19. The use of the stop member 117 is more critical in the wider design as the width permits greater horizontal play than the narrower designs.

In the preferred embodiment, the release mechanism 60, illustrated in FIG. 7, consists of a release bar 62, interior support 64, metal brace 66 and brace feet 68. The folding release mechanism 60 is connected to internal wiring that interacts with the locking systems disclosed herein.

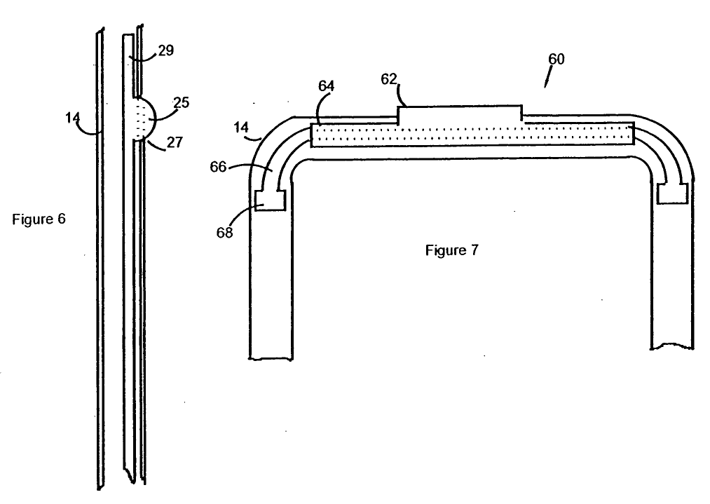

In an alternate embodiment the locking mechanisms that can be controlled through the use of locking buttons, rather than the slide releases, is the positioning of the handles 314 and 312, as illustrated in FIG. 6. At one or more locations, depending upon manufacturing preference, there are button locks 325 that interact with exit holes 327 positioned along the lower handle 314. When the button locks 325 protrude through the exit holes 327 and are aligned with the receiving holes 332 in the upper handle 312, the upper handle 312 and lower handle 314 are locked into position; releasing when the button locks 325 are withdrawn. To release the button lock 325 from a locked position and move the upper handle 312 either up or down, the release bar 62 is pressed downward forcing the inner support 64 toward the opposing wall. This forces the button retaining member 329 to move to the opposing wall, thereby removing the button lock 325 from the receiving hole 332.

The locking mechanism 60 as illustrated in FIG. 7 is placed on the lower handle to release the platform 160 from the open position as illustrated in FIG. 22. The platform 160 has a flange 172 that has a receiving hole 170 to receive the locking button 174 extending from the leg 154. The locking button 174 is connected to the locking mechanism 60 as noted herein and is withdrawn from the receiving hole 170 upon the application of pressure to the release bar 62. Once released, the platform 120 is free to rotate to the closed position.

To provide additional storage and stability, the preferred embodiment of the disclosed tote can have a larger platform 120, as illustrated in FIG. 8, than prior art totes. In order to accommodate this increased width, the preferred folding release mechanism 60, n which can be used with either handle, is placed in the lower handle (not shown). The release bar 62 is integral with, or securely connected to, the interior support 64 which has been formed, or molded, around a metal brace 66. The metal brace 66 ends in brace feet 68 which can be any design compatible with the locking mechanism being used. It should be noted that this handle release design can be used to release any of the locking embodiments disclosed herein, as well as any other locks incorporated in to the tote design. In the preferred embodiment the locking mechanism placed in the lower handle releases both the lock maintaining the platform in the open position as well as the lock maintaining the platform in the closed position. The disclosed folding release mechanism 60 can be used with smaller designs of the disclosed tote, however its criticality comes in when used with the wider handles required on the larger tote design. This strengthened design enables the maximum depression required to operate the wider folding release mechanism 60 with minimum deflection within the handle.

The use of the metal brace 66 provides the strength and stability required to prevent the interior support 64 from buckling when the release bar 62 is pressed downward. Since there is opposing pressure from the locking mechanism, if the interior support 64 is unable to have sufficient strength to counter that pressure, it will buckle, preventing the release button locks disclosed herein from withdrawing from the receiving holes. Although this added support is not necessary in the smaller totes, the extra width of the preferred embodiment causes buckling when only an interior support is used.

In embodiments where there is an increase in the dimensions of the tote 100, a problem is created in that the bag 104 can easily catch during the folding process. To overcome this issue, an elasticized strap 102 is added to each side of the bag 104 to pull the front of the bag 104 toward the handle 106. This facilitates the folding process by automatically maintaining the front of the bag 104 in a compressed position; eliminating the need to adjust or hold the bag 104 during the folding process. To fully utilize space, the elasticized strap 102 can be the top part of a part of a mesh pocket 108 to enable items to be carried on the side of the bag 104.

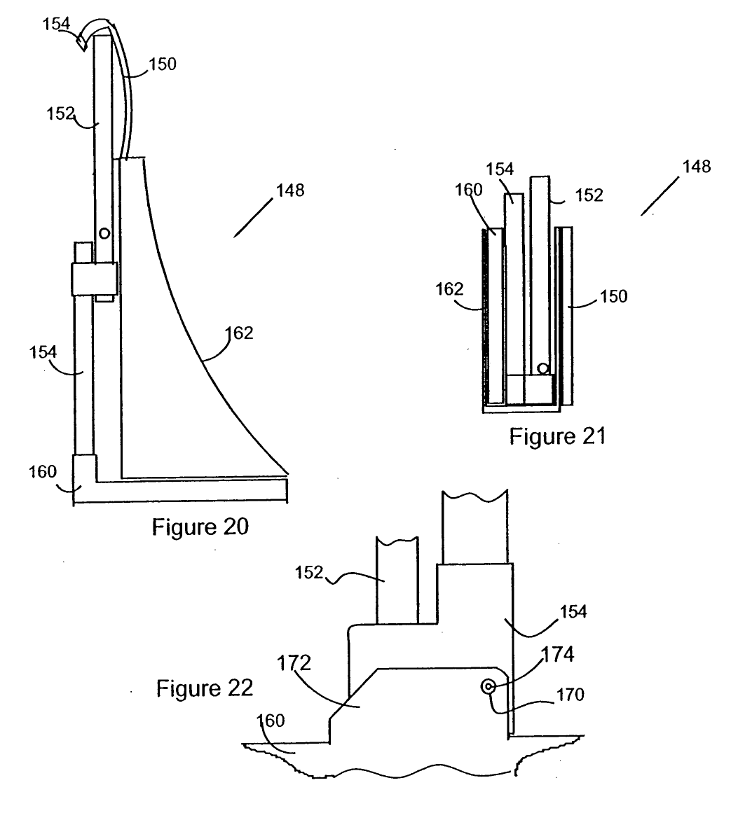

The dimensioning of the cover 130 also increases in criticality as the overall dimensions increase. In order to permit the tote 100 of FIGS. 20 and 21 to fold, as illustrated heretofore, the cover 130 must have a length equal to, or slightly less than, that of the platform 120 to prevent overhang when the tote 100 is in the folded position. However, there must also be sufficient length to cover the filled bag 104, as well as maintain the cover 130 in the open position. The cover 130 can be maintained in the open position by either providing sufficient length to extend over the raised handle 112 or through the use of magnets as described in FIG. 9. If the cover 130 is to be placed over the extended handle 112, there must be sufficient length to place the weight of the cover handle 132 onto the reverse side of the upper, while not interfering with the closing of the tote 100. To do this, the distance between where the bag 104 is attached to the handle 112 and the top of the handle 112 must be less than the depth D of the platform 120 by the amount of desired overlap of the cover 130. Weight can be added to the cover 130 when necessary to provide the balance to maintain the cover 130 in the open position. This can be in the form of a handle, weight added directly to the cover open end or other methods known in the art. In the event the dimensions of the tote are such that the cover cannot have sufficient length to fold over the top of the handle, magnets or other securing methods can be used.

As seen in FIG. 9, hook and loop material strips 140 and 142 are added to the bag 104 with the opposing strip 136 being added to the cover 130. In this embodiment, an extra front pocket 144 has been added, however, additional pockets of any design can be used, either on the front or back. If the pocket 144 is not used a single strip of hook and loop can be used to secure the cover, however when pockets are used, additional hook and loop material can berequired. The length of the hook and loop material should be sufficient to permit the cover 130 to be secured at several positions, thereby enabling the cover 130 to be secured whether the bag 104 is completely or partially full. Although reference is made to hook and loop material it should be noted that any fastening method, such as weights, buttons, snaps, loops, ties, etc., can be used to secure the cover in a single or multiple position.

Preferably the cover 130 is secured to the tote bag 104 through use of metal brace 134. In addition to providing an area through which to secure the cover 130, the rigid metal brace 134 provides a rigidity for the soft cover 130 unobtainable through directly securing the cover 130 to the handle 122.

In the illustrated embodiment, the unsecured end of the cover 130 is covered by a semi-rigid plastic handle 132 to provide structure to the cover 130 as well as a gripping area for the user. It should be noted that the handle can be any size or design convenient for manufacture, provided it does not extend the length of the cover 130 to be greater than the width of the platform 120.

As also illustrated in FIG. 9, a magnetic insert 146, or series of magnets, can be placed within the cover handle 132 to cause the plastic cover handle 132 to magnetically affix to the handle 122. The handle 122, if not manufactured from a magnetic material, can be magnetized by inserting a magnet, or magnetic strip, into the handle 122 proximate the area contacted by the cover handle 132. This is especially important when used in conjunction on the smaller totes to obtain the correct proportions for closing, the cover cannot have a length sufficient to lie over the handle and must rely on the magnetic system to remain open. When incorporating the use of magnets within the tote, it will be obvious to those skilled in the art that compatible metals must be used either in the construction of the applicable areas or adhere to the standard materials.

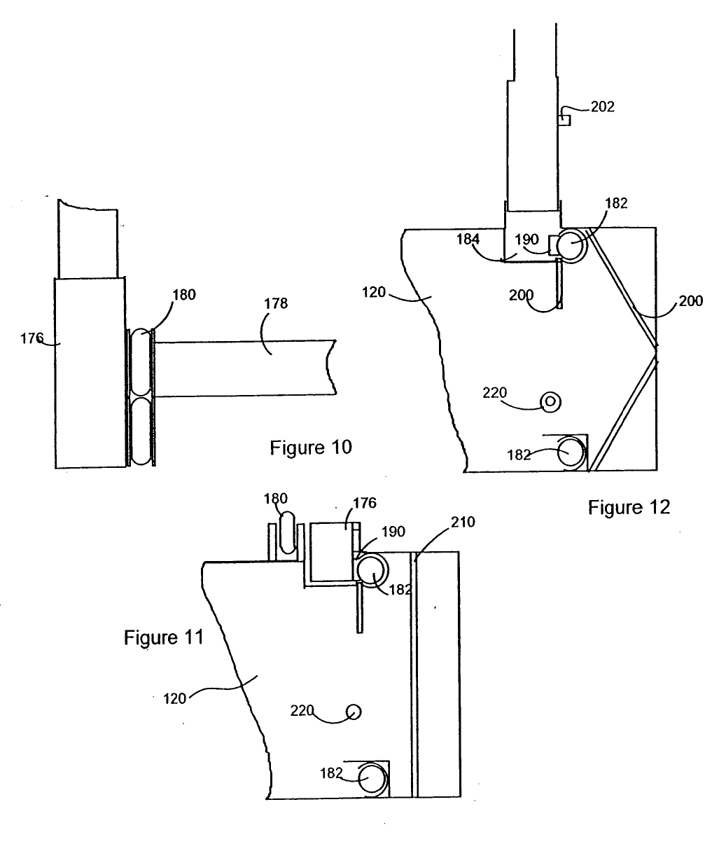

In order to make carrying the any of the tote embodiments disclosed herein up the stairs easier, at least one pair of rotating spacers 180, proximate each leg block 176 and illustrated in FIGS. 10 and 11, is placed on the platform edge 178 adjacent to each of the leg blocks 176. Thespacers 180 should extend slightly beyond the leg blocks 176 a sufficient distance to enable the contact to be between the stairs and the spacers 180 rather than the stairs and the leg blocks 176. Alternatively, a tread similar to that used by a tank, can be used.

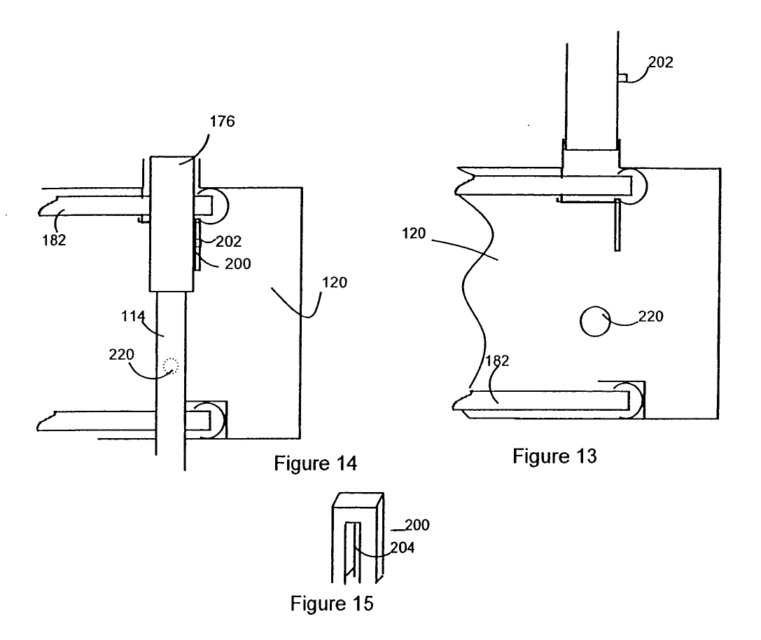

In FIGS. 11-14, the under portion of the platform 120 is shown. In FIG. 11 the tote is illustrated in the locked, in-use position with the support leg 182 in the open position and the platform 120 at right angles to the leg blocks 176. As noted heretofore, the leg 114 is maintained in the open locked position through use of the locking button 174. Once the release bar 62 is pressed, moving the locking button 174 toward the opposing wall of the leg 114 and away from the receiving hole 170, the platform 120 is free to rotate. In FIG. 12 the tote is in the first stage of folding with the leg blocks 176 on the same plane as the platform 120. In FIG. 13 the support frames 182 have been folded adjacent to the platform 120 and in FIG. 14, the handle braces and handle 114 are folded over the support frame 182 and locked into position. The platform 120 is maintained in the locked position through the interaction of the locking button 174 with the locking bracket 200.

Through this design the locking button 174 serves to lock the platform 120 in both the open and closed positions, thereby allowing a single release mechanism 60 to be used for both operations.

The support leg 182 in FIGS. 11 and 12 has been cut away in order to more clearly illustrate the various components. In FIG. 11 the positioning of the spacer 180 can be seen extending slightly beyond the plane of the leg block 176. As seen in FIGS. 11 and 12, in order to prevent the leg block 176 from side to side movement and compensate for any manufacturing discrepancies, a friction pad 190 is affixed to the leg 182. The friction pad 190 can be manufactured from any resilient, semi-rigid material, such as rubber, that will permit a friction fit between the pad 190 and the leg block 176.

As seen in FIGS. 12 and 13, the locking button, when the handle 114 is in its folded position as illustrated in FIG. 14, interacts with the locking bracket 200. The locking bracket 200, shown in detail in FIG. 15, has a receiving channel 204 which is dimensioned to receive the lock button 174. The top of the locking bracket 200 is beveled to receive the uncompressed locking button 174 forcing it to compress as it slides along the bracket 200 until it contacts the receiving channel 204. Once the support frame 182 are closed, as see in FIG. 13, the handle 114 is closed, FIG. 14, with the lock button 174 being held within the receiving channel 204.

To open the tote by releasing the locking button 174, the handle 62 is depressed and the interior locking mechanism forces the locking button 174 into the handle 107, permitting the platform 120 to drop away from the handle 107. Since the bag 104 is attached to the handle 106 as well as the platform 120, as the handle 106 is pulled upward the bag 104 is also pulled, thereby positioning the platform 120 at a 90° to the handles 106 and 107. The weight of the wheels 116, as well as the opposing pressure exerted by separating the upper handle 106 and the lower handle 107, forces the support frame 182 in to the correct position where it is locked in place by the placement of the locking button 174 with the receiving hole 170 within the leg block 176. It should be noted that the use of the handle 62 to release the locking button 174 in both the open and closed position provides another feature that simplifies use of the device.

To assist in the automatic opening of the platform 120, a spring release 220 is positioned to come in contact with the leg regions 114. The spring release 220 is positioned within a raised carrier 222 that positions the spring release 220 a sufficient distance from the platform 120 be in a compressed state when the tote is closed. Once the locking button is released, the pressure applied by the spring release 220 assists in pushing the handles 106 and 107 away from the platform 120. Although the spring release 220 is illustrated positioned on the platform, approximately centered between the front and back of the platform any location that contacts the leg regions 114 and/or 112 can be used.

To increase the rigidity of the platform, ribs 230 can be place diagonally along the comers or any other locations that would provide additional rigidity to the platform.

Any specific item disclosed herein, such as the stop member to maintain the locking slides horizontal, can be used with any of the disclosed embodiments and the description with a specific embodiment is not intended to limit the scope of the invention.

What is claimed is:

1. A folding tote comprising a platform having a width and a depth and a first side and a second side, said platform supporting a carrying bag on said first side and foldable support frame and wheels on said second side, and a pair of inverted U shaped hollow handles, each of said handles having an interior surface, an exterior surface, a horizontal bar and a pair of hollow leg regions, a first of said pair of handles having said leg regions rotatably affixed to a first edge of said platform, said carrying bag having a closed end affixed to said platform and an open end affixed at a first side to one of said pair of handles, the improvements comprising:
at least one locking mechanism,
a release mechanism on a first of said handles, said release mechanism being connected, through the interior of said hollow leg regions, to release said at least one locking mechanism.

2. The tote of claim 1 wherein said release mechanism comprises:
a release bar, said release bar extending beyond said exterior surface of said horizontal bar of a first of said pair of handles;
an inner support member within said interior of said horizontal bar, said inner support member being integral with said release bar;
a rigid brace a portion of said rigid brace being within said inner support for reinforcement and a portion of said rigid brace extending beyond said inner support member into each of said hollow leg regions,
each end of said rigid brace extending into said hollow leg regions being connected to each of said at least one locking mechanism.

3. The tote of claim 2 wherein said at least one locking mechanism is at least one tension loaded locking button within said leg regions of said first handle proximate said exterior surface, each of said at least one locking button being connected to said release mechanism and moving from extending beyond said exterior of said hollow leg regions of said first handle toward an opposing wall upon the application of pressure to said release bar and back toward said exterior upon release of said pressure from said release bar,when said platform is in an open position said locking button is received by at least one receiving hole in a platform flange proximate said leg region, said receiving hole being positioned to receive said locking button to lock said platform at about a 90 degree angle from said pair of handles and when said locking button is released, said platform is free to rotate to about a 270 degree angle from said pair of hollow leg regions, and
when said platform is in a closed position said locking button is received by at least one receiving slot in an angled receiving flange, said angled receiving flange being affixed to said second side of said platform to receive said locking button to lock said platform in a closed position.

4. The tote of claim 2 wherein said at least one locking mechanism locks said platform at about a 90 degree angle to said handles.

5. The tote of claim 2 wherein said at least one locking mechanism locks said platform adjacent to said handles.

6. The tote of claim 2 wherein said at least one locking mechanism locks said platform at about a 90 degree angle to said handles in an open position and said platform adjacent to said handles in a closed position.

7. The tote of claim 2 wherein said handle locking mechanism is at least one tension loaded button within a first wall of said first handle and receiving holes in a second wall of a second of said handles, said buttons being connected to said feet of said release mechanism and moving from extending beyond said first wall of said first handle toward an opposing wall upon the application of pressure to said release bar and back toward said first wall upon release of said pressure from said release bar, wherein when said handles are positioned such that when said receiving holes are aligned to receive said buttons, said handles are locked into position.

8. The tote of claim 1 wherein a distance from a point of said carrying bag being affixed to said hollow leg regions of a second of said pair of inverted U shaped handles is less than said depth of said platform to enable said platform to close and lock.

9. The tote of claim 8 wherein said carrying bag has a cover, said cover having a length greater, when said tote is in the open position, than said distance from the point of said carrying bag being affixed to said hollow leg regions to said horizontal bar but less than said depth of said platform.

10. The tote of claim 1 wherein said carrying bag has an elastic member proximate said open end, said elastic member extending from said first side to an opposing third side, said elastic maintaining said third side proximate said first side to facilitate said carrying bag being folded.

11. The tote of claim 1 further comprising a pair of slide releases, said slide releases locking said first handle in a position relative to the second handle.

12. The tote of claim 11 further comprising a pair of stop members, each of said stop members extending from said exterior surface of said second handle and distanced from an end of each of said hollow leg regions of said U-shaped handle, said stop members contacting said slide releases to enable said slide releases to move simultaneously.

13. The tote of claim 1 further comprising rotating spacers, said rotating spacers extending beyond the exterior plane of said platform adjacent to each of said legs and preventing said platform from contacting a surface.

14. The tote of claim 5 wherein said locking mechanism is at least one tension loaded locking button with said first handle proximate said exterior surface of at least one of said hollow leg regions of said first handle, said locking button interacting with an angled receiving flange, said receiving flange having a receiving slot positioned to receive said locking button, said angled receiving flange being affixed to said second side of said platform to receive said locking button each of said at least one locking button being connected to said feet of said release mechanism and moving from extending beyond said exterior of said hollow regions of said first handle toward an opposing wall upon the application of pressure to said release bar and back toward said exterior upon release of said pressure from said release bar to engage with said receiving slot to lock said platform in a closed position.

15. The tote of claim 1 further comprising a spring release, said spring release being positioned on said second side of said platform to be in contact with said leg regions when said tote is in a closed position to push said platform away from said leg regions when said locking mechanism is released.

16. The tote of claim 1 wherein said second side of said platform further comprises structural support members.

17. The tote of claim 4 wherein one of said at least one locking mechanism is at least one tension loaded locking button within said first handle proximate said exterior surface of at least one of said leg region that is received by at least one receiving hole in a platform flange proximate said leg region, said receiving hole being positioned to receive said locking button, each of said at least one locking button being connected to said feet of said release mechanism and moving from extending beyond said exterior of said hollow regions of said first handle toward an opposing wall upon the application of pressure to said release bar and back toward said exterior upon release of said pressure from said release bar to engage with said receiving hole in said platform flange, wherein when in a locked position said platform is at about a 90 degree angle from said pair of handles and when said locking button is released, said platform is free to rotate to about a 270 degree angle from said pair of hollow leg regions.

18. The tote of claim 1 further comprising a friction pad, said frication being braced within said platform adjacent to the rotation point of said leg region to prevent side-to-side movement of said leg region.

19. A folding tote comprising a platform having a width and a depth and a first side and a second side, said platform supporting a carrying bag on said first side and foldable support frame and wheels on said second side, and a pair of inverted U shaped hollow handles, each of said handles having an interior and an exterior surface, a horizontal bar and a pair of leg regions, a first of said pair of handles having said leg regions rotatably affixed to a first edge of said platform, said carrying bag having a closed end affixed to said platform and an open end affixed at a first side to one of said pair of handles, the improvements comprising:
a release mechanism on said horizontal bar of a first of said handles, said release mechanism having:
a release bar, said release bar extending beyond said exterior surface of said horizontal bar of a first of said pair of handles;
an inner support member within said interior of said horizontal bar, said inner support member being integral with said release bar,
a rigid brace a portion of said rigid brace being within said inner support for reinforcement and a portion of said rigid brace extending beyond said inner support member into each of said leg regions, at least one locking mechanism,
a first of said at least one locking mechanism being at least one tension loaded locking button proximate an end of one of said leg regions and connected to said rigid brace,
a first receiving area, said first receiving area being a receiving hole in a platform flange to receive said locking button to lock said platform at about a 90 degree angle to said handles,
a second receiving area, said second receiving area being a receiving hole in receiving hole in an angled receiving flange, said angle receiving flange being affixed to said second side of said platform to receive said locking button to lock said platform adjacent to said leg regions,
a spring release, said spring release being position on said second side of said platform to be in contact with said leg regions when said tote is in a closed position.

20. The tote of claim 18 further comprising a pair of slide releases to lock said leg regions of said first handle in a position relative to said leg regions of said second handle and a pair of stop members, each of said stop members extending from said exterior surface of said second handle and distanced from an end of each of said leg regions, said stop members contacting said slide releases to enable said slide releases to move simultaneously.

20. A folding tote comprising a platform having a width and a depth and a first side and a second side, said platform supporting a carrying bag on said first side and foldable support frame and wheels on said second side, and a pair of inverted U shaped hollow handles, each of said handles having an interior and an exterior surface, a horizontal bar and a pair of leg regions, a first of said pair of handles having said leg regions rotatably affixed to a first edge of said platform, said carrying bag having a closed end affixed to said platform and an open end affixed at a first side to one of said pair of handles, the improvements comprising:
a release mechanism on said horizontal bar of a first of said handles, said release mechanism having:
a release bar, said release bar extending beyond said exterior surface of said horizontal bar of a first of said pair of handles;
an inner support member within said interior of said horizontal bar, said inner support member being integral with said release bar,
a rigid brace, a portion of said rigid brace being within said inner support member for reinforcement and a portion of said rigid brace extending beyond said inner support member into each of said leg regions, each end of said rigid brace having feet within said leg regions.
